(19) United States
(12) Patent Application Publication
(10) Pub. No.: US 2003/0169045 A1
(43) Pub. Date: Sep. 11, 2003

(54) Method and apparatus for a rigidly joined together and floating bucking and receiver coil assembly for use in airborne electromagnetic survey systems

(76) Inventor: Raymond Macklin Whitton, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/378,850

(22) Filed: Mar. 5, 2003

Related U.S. Application Data
(60) Provisional application No. 60/361,696, filed on Mar. 6, 2002.

(51) Int. Cl. G01V 3/16

(52) U.S. Cl. 324/330; 324/331

(57) ABSTRACT

A housing and bucking coil and receiving coil system for a helicopter towed concentric coil electromagnetic survey system that reduces micro phonic and primary field noise. The device includes an isolation housing, a bucking coil and receiving coil assembly with structural members to rigidly join the two coils together and a suspension system to suspend the joined bucking and receiving coils, in a floating manner, by bungee cords or similar non-metallic vibration dampening devices. A housing with dimensions large enough to enclose the suspended bucking and receiving coil assembly that is lined with acoustic and other vibration dampening material A method for suspending the joined bucking and receiving coil assembly that isolates the assembly from vibration and at the same time keeps the coil assembly from twisting and turning in angular planes from the plane of the transmitter, wherein the acceptable minor motions the coil assembly will be allowed to make by the suspension system are up-down, back-forward and left-right motions.

### FIELD OF THE INVENTION

This invention relates to the field of helicopter towed airborne electromagnetic surveying, generally.

### BACKGROUND OF THE INVENTION

An airborne electromagnetometer survey system is a device that, from above the ground, detects conductors on or below the earth's surface. It is an instrument primarily used in mineral exploration for detecting conductive minerals such as, for example, nickel and copper. An airborne electromagnetometer has a transmitter and a receiver. The transmitter creates a magnetic field that enters a conductor in the ground. The induced magnetic field in the conductor causes eddy currents to flow around the surfaces of the conductor. The eddy currents generate secondary magnetic fields. The receiver or receivers measure these secondary magnetic fields.

There are two major types of airborne electromagnetic survey systems; frequency domain and time domain. Both types of survey systems may be flown with fixed-wing or helicopter platforms. Therefore there are a possibility of 4 combinations of the electromagnetometer types and airborne platforms. The invention relates to helicopter towed electromagnetometer systems.

All electromagnetometer systems include a transmitter coil or multiple transmitter coils and a receiver coil or multiple receiver coils. Some electromagnetometer systems include a bucking coil or multiple bucking coils. There are a number of different configurations of electromagnetometer survey systems in regards to the positioning and orientation of these coils. The invention relates to electromagnetometers that have a bucking or multiple bucking coils.

The invention relates to a helicopter towed electromagnetometer survey system, time domain or frequency domain, with a concentric transmitter, bucking and receiver coil set positioned horizontally and/or vertically. The receiver coil may consist of multiple coils, each with different orientations. For greater clarity, it should be understood that reference to the term “coil” in conjunction with “receiving”, “transmitting” or “bucking” is intended to encompass both “coil” and “coils”, unless a contrary intention is indicated.

Glossary

The following describes some technological terms used by the airborne electromagnetomer survey industry that are used throughout this document.

The term “transmitter coil” refers to a coil with one or more windings that, when current is applied, transmits an electromagnetic field. The transmitted field may be continuous or intermittent. The waveform shape of the field may be a square wave, a sinusoidal wave or some other transmitted waveform

The term “primary field” refers to the electromagnetic field generated by the transmitter coil.

The term “secondary field” refers to the electromagnetic field generated by a conductor as a result of its being exposed to the primary field of the transmitter coil.

The term “receiver coil” refers to a coil with one or more windings where the secondary field induces electrical signal. The signal measured from the receiver coil windings is directly related to the secondary field changes.

The term “airborne electromagnetometer” or “electromagnetometer” refers to an instrument that has a transmitter coil or coils, possibly bucking coil or coils and receiver coil or coils that measures the secondary field caused by a conductor when the conductor is exposed to the primary field of the transmitter.

The term “bird” or “bomb” refers to the housing for the receiver coil or coils that is towed on the end of a cable by the helicopter or fixed-wing survey aircraft. The housing is often shaped like a bomb with tail fins for directional purposes.

The term “bird” also refers to an entire electromagnetometer survey system when it is an integrated unit being towed by an aircraft and hanging off the end of the tow cable. The bird may be any shape as dictated by the requirements of the electromagnetometer system.

The term “tow-cable” refers to the cable connected to the fixed-wing or helicopter aircraft that is used to tow a bird. The tow cable contains a structural stress member or members to carry the weight load of the bird being towed. The tow cable contains wire and/or fiber optics to carry signals from the bird to the aircraft. The tow cable may contain wire or wires that carry power and signals between the bird and the aircraft.

The term “drag-chute” refers to a device employed with an electromagnetometer that provides drag as the system moves through the air. The drag-chute is placed in a position relative to the electromagnetometer that causes the electromagnetometer to maintain a directional alignment in flight while the system is moving through the air.

The term “bucking coil” refers to a coil with one or more windings whose purpose is to cancel the effect of the primary field into the receiver coil.

The term “active bucking” refers to when the transmitter coil and the bucking coil are connected in series and the bucking coil is energized with the same current as is the transmitter coil.

The term “passive bucking” refers to when the bucking coil and the receiver coil are connected in series and the only current passing through the bucking coil is induced.

The term “un-bucked” refers to the state where the effect of the primary field is not canceled and the receiver coil is affected by the primary field.

The term “horizontal coil” refers to a coil physically positioned on the horizontal plane, like a wheel lying on its side, whose axis is vertical.

The term “vertical coil” refers to a coil physically positioned vertically, like a wheel in its upright position, whose axis is horizontal.

The term “coaxial coils” refers to a coil set, where all the coils have the same axis.

The term “coplanar coils” refers to a coil set, where the axes of all the coils are parallel to each other.

The term “concentric coils” refers to a coil set where all the coils have the same center.

The term “bird flex” refers to independent movements of the transmitter coil or coils, the bucking coil or coils and/or the receiving coil or coils in relation to each other. Bird flex is usually the result of insufficient rigidity in the structure in which the coils are attached or a part of.

The term “micro phonics” refers to the effects caused by the receiver coil or coils vibrating in the ambient magnetic field that result in noise being picked up in the received signal. The vibration of the exterior structural components of the electromagnetometer usually causes the micro phonic effects.

The term “off-time” is used with time domain electromagnetic systems and refers to the period of time the transmitter coil is shut off and has no current running through it.

The term “on-time” is used with time domain electromagnetic systems and refers to the time period the transmitter coil has current running through it and is transmitting a signal.

The term “in-phase” is used with frequency domain electromagnetic systems and refers to the component of the secondary field whose phase difference with the primary field is zero degrees.

The term “quadrature” is used with frequency domain electromagnetic systems and refers to the component of the secondary field whose phase difference with the primary field is 90 degrees.

Definition of a Time Domain System

The transmitter coil is energized by current pulses. Different shape current pulses could be used. The information recorded by the system is the signal, induced by the secondary field into the receiver coil or coils. All time domain electromagnetic systems record the secondary field information during the off-time period. Some fixed-wing electromagnetic systems with transmitter coils attached to the aircraft and with towed receiver birds have been developed and are successfully recording secondary field information during the on-time transmitter period.

Frequency Domain System

The transmitter coil or coils are continuously energized with a waveform at a predefined frequency or multiple predefined frequencies. The information recorded by the system is the signal, induced by the secondary field into the receiver coil or coils. The survey system may have coaxial and/or coplaner transmitter coils that transmit on one or more predefined frequencies or a single transmitter coil may transmit multiplexed predefined frequencies. The secondary field information measured by the receiver coil or coils is processed into in-phase and quadrature components.

Helicopter Towed Frequency Domain Electromagnetic Survey System

A majority of the helicopter towed frequency domain survey systems involve a helicopter with a cable connected to its cargo hook and an electromagnetometer suspended at the end of the cable.

The invention does not relate to conventional helicopter towed frequency domain electromagnetometer systems. The following is a description of such a conventional system and is included for definitive purposes only:

The conventional electromagnetometer is usually a tube of about 0.5 meters in diameter and about 6 or 7 meters long. It is usually manufactured out of fiberglass and resin or Kevlar and resin. There is usually a device called a drag chute positioned at one end of the tube that forces the bird, when towed through the air, to align itself in the direction of flight. Inside the tube are three kinds of coils; transmitter, bucking and receiver. There may be more than one set of these coils in the bird and each set of coils may be oriented in the coaxial and/or coplanar orientations. The transmitter and receiver coil or coils are positioned at opposite ends of the tube and the bucking coil is usually in the middle of the tube.

The invention does relate to helicopter towed frequency domain electromagnetometer systems that have concentric coaxial transmitter, bucking and receiving coils. The following is a description of such a system:

The bucking coil or bucking coils and the receiver coil or receiver coils are positioned interior to the transmitter coil with the same center as the transmitter coil or transmitter coils. The receiver coil or coils are positioned interior to the bucking coil or coils. All the coils are concentric.

The transmitter coil is energized with a current at a specific frequency or a number of combined specific frequencies. The bucking coil isolates the receiving coil from the primary field and the receiving coil measures only the signal related to the secondary field.

There are two electrically different methods of configuring the bucking coil or coils.

1) Active Bucking: The transmitter coil and the bucking coil are connected in series. Thus the current through the transmitter coil, creating the primary field flows through the bucking coil also. The bucking coil's electromagnetic field in the vicinity of the receiver coil is equal to the primary field and opposite to it. Thus the primary field is canceled in the vicinity of the receiver coil and the receiver coil doesn't see it.

2) Passive Bucking: The bucking coil and the receiver coil are connected in series. The current, induced by the primary field in the bucking coil is equal in amplitude, but opposite in direction to the one induced in the receiver coil. Thus no current induced by the primary field floats into both the bucking coil and the receiver coil and the receiver coils appear to be isolated from the primary field.

The invention is intended to solve mechanical problems that are inherent in electromagnetic systems employing either bucking method.

Helicopter Time Domain Electromagnetic Survey System

There are a variety of helicopter time domain survey systems that have been designed. Some of them are currently in use. All helicopter time domain systems include a transmitter coil or coils and a receiver coil or coils. Some helicopter time domain systems include a bucking coil or coils. The following paragraphs describe the physical characteristics of different types of helicopter time domain systems:

a) A helicopter time domain survey system with the transmitter coil rigidly attached to the helicopter on the ends of booms radiating from the center of the helicopter. A receiver coil or receiver coils are housed in a bird or bomb that is towed below and behind the helicopter at a distance that minimizes the effects of the primary field. This type of helicopter time domain system is very similar to a fixed-wing type of time domain system.

b) A helicopter time domain survey system with a cable attached to the helicopter's cargo hook and the transmitter coil attached to the other end of the cable. A receiver coil or receiver coils are housed in a bird or bomb that is towed below and behind the transmitter coil or suspended in some manner on the same plane as the transmitter coil and behind the transmitter coil. The separation of the receiver coil or coils from the transmitter coil or coils is at a distance that minimizes the effects of the primary field.

c) A helicopter time domain survey system with a cable attached to the helicopter's cargo hook and an electromagnetometer suspended at the other end of the cable. The electromagnetometer is a device with concentric coaxial transmitter, bucking and receiver coils or coils. This system is similar to the helicopter towed frequency domain survey system in regards to the rigidity requirement. The assembly consisting of the transmitter, bucking and receiver coils or coils must be maintained absolutely rigid. Otherwise the receiver coil, moving independently to movements of the bucking and transmitter coils caused by the flexing of the electromagnetometer, will measure variations in the primary field.

Helicopter towed time domain electromagnetometers of types a) and b) above are not the focus of the invention. The invention is focused on resolving multiple problems with electromagnetometer type c) above.

All of the current helicopter time domain survey systems employ off-time measurements. I believe that none of the systems are currently capable of providing good on-time data because of the physical distance the bird is from the transmitter coil or because of the flexing in the concentric coil electromagnetometer system.

Comparison of Frequency and Time Domain Systems

The focus of the invention is towards resolving a mechanical problem or mechanical problems on helicopter towed frequency and time domain electromagnetic survey systems that have concentric coaxial transmitter, bucking and receiving coils. There are very few mechanical differences between the time and frequency domain versions of such systems. The major difference is in how the transmitter is energized. A time domain transmitter is pulsed with a waveform then it is shut off for a period of time. A frequency domain transmitter carries a continuous waveform.

Early designs of helicopter towed frequency and time domain survey systems had poor suspension systems. The bird would suffer from vibrations that would negatively influence the measurements read from the receiver coil or coils. The receiver coil or coils would vibrate and the ambient field would induce a noise in the receiver coil on top of the received secondary signals from the ground. This phenomenon is called micro phonics. Modern designs of helicopter towed frequency and time domain survey systems include suspension systems that isolate the bird from the tow cable and drag chute. A bungee cord or bungee cords are usually used for the suspension. The rubber in the bungee cords dampens the vibrations of the tow cable and drag chute. The receiver vibrates less and the micro phonic effects are less.

Early frequency domain electromagnetometer bird tubes of types a) and b) above were made from wood. Later designs replaced the wood with fiberglass and resin construction. Recent designs of frequency and time domain electromagnetometers all use Kevlar threads and resin construction for strength and rigidity. The evolution from wood then to fiberglass then to Kevlar was made to reduce bird flex. It is absolutely crucial to maintain the transmitter, bucking and receiver coils rigidly positioned relative to each other. Minute flexing will cause the receiver coil to become “un-bucked” and see some of the transmitted primary field. Due to the rigidity requirement all of the helicopter towed frequency domain survey systems currently in use are rather small. Larger systems could be built electronically but they would not be rigid enough to do productive surveying with. Due to the rigidity requirement all of the helicopter towed time domain systems are capable of only measuring good usable data during off-time transmitter periods.

### SUMMARY OF THE INVENTION

The present invention is directed towards a means of obtaining usable on-time measurements from a helicopter towed time domain electromagnetometers with concentric coaxial transmitter, bucking and receiver coil or coils and a means of reducing measurement noise caused by vibrations and bird flex in helicopter towed frequency domain electromagnetometers with concentric coaxial transmitter, bucking and receiver coils or coils.

The applicant understands that, by rigidly joining the bucking and receiving coil or coils and suspending the assembly with vibration dampening devices such as bungee cords or other vibration dampening devices, the received signal will be less influenced by micro phonics and bird flex motion within the transmitted primary field.

The subject device includes a receiver coil, a bucking coil, a transmitter coil, structural assembly components and bungee cords or other vibration dampening devices. The invention involves rigidly joining the bucking coil and the receiver coil together and suspending the joined assembly with bungee cords or other vibration dampening devices in the position normally occupied by these coils. The invention is focused on isolating the receiver coil from electronic noise created and measured by the receiver when it is vibrating in the ambient magnetic field and minimizing the effects of the receiving coil when it is moving independently from the bucking and/or transmitter coil or the effects of the bucking coil when it is moving independently from the transmitter and/or receiving coil as happens when the bird flexes.

The invention is a method of minimizing the degrading vibration and the effects of structural flexing in an electromagnetometer system. The method comprises the steps of:

A. using known techniques, calculating the ideal locations for the bucking and receiving coils in respect to the transmitter coil.

B. fabricating the bucking coil and receiving coil as a single and rigid assembly using the calculated diameters and number of wire windings for each of the bucking and receiving coils.

C. using known techniques, fabricating the transmitter coil and other structural electromagnetometer components as a single rigid structure.

D. fabricating an egg or tube or other shaped housing whose interior is bigger than the bucking and receiving coil assembly and placing the housing in the location that enables the bucking and receiving coil assembly to be positioned inside the housing at the ideal calculated bucking and receiving coil location.

E. suspending the bucking and receiving coil assembly within the egg or tube or other shaped housing by means of bungee cords or other vibration dampening devices in a manner that minimizes the bucking and receiving coil angular movement in respect to the transmitter coil but does allow the assembly to move up and down, forward and backward or left and right or any combination of these movements in order to dampen induced movement caused by vibrations and/or bird flexing.

F. insulating the interior of the egg or tube or other shaped housing with a material that reduces acoustic and other vibrations that originate from the vibration harmonics of the exterior structural electromagnetometer components as they are affected by wind and other sources of vibration as the electromagnetometer is moving through the air.

### BRIEF DESCRIPTION OF THE DRAWINGS

The present invention will now be described, by way of example only, with reference to the following drawings, in which like reference numerals refer to like parts and in which:

FIGS. 1a and 1b are a pair of schematic diagrams showing the top and side cut-away views of a rigidly assembled concentric bucking and receiving coil assembly for use in a helicopter towed electromagnetometer with concentric coaxial transmitter, bucking and receiving coils.

FIGS. 2a and 2b are a pair of schematic diagrams showing the top and side cut-away views of a rigidly assembled bucking and 3-axis receiving coil assembly (one of the receiving coils is coaxial with the bucking coil) for use in a helicopter towed electromagnetometer with concentric coaxial transmitter, bucking and one axis of the receiving coils.

FIGS. 3a and 3b are a pair of schematic diagrams of the side view of the container that houses the rigidly assembled concentric bucking and receiving coil assembly, one view (3a) is with the container closed and the other view (3b) is a cut-away view showing the inside of the container.

FIG. 4 is a schematic diagram of a cross section of one of the container structural members with part of the housing skin bolted to it and with layers of vibration dampening material affixed to the inside.

FIGS. 5a, 5b and 5c are schematic diagrams of a helicopter towed electromagnetometer with concentric transmitter, bucking and receiving coils. FIG. 5a is the top perspective view. Figures 5b and 5c are a pair of schematic diagrams of the side perspective view of a helicopter towed electromagnetometer. 5b shows the side view with a container in the center that houses the suspended and rigidly joined bucking and receiving coils. FIG. 5c is a cut-away view of FIG. 5b showing the interior of the container.

FIG. 6a is a schematic diagram in side cut-away view of the container in a helicopter towed electromagnetometer with a bucking coil and single axis receiving coil assembly installed in the housing.

FIG. 6b is a schematic diagram in side cut-away view of the container in a helicopter towed electromagnetometer with a bucking coil and 3-axis receiving coil assembly installed in the housing.

### DETAILED DESCRIPTION OF THE PREFERRED EMBODIMENT

The subject invention incorporates a rigid coil assembly component and a suspension system and a housing. The rigid coil assembly component is suspended inside the housing. For diagram purposes the subject electromagnetometer system is shown in hexagonal form, the subject invention may be in any other form as well such as circular, octagonal, etc.

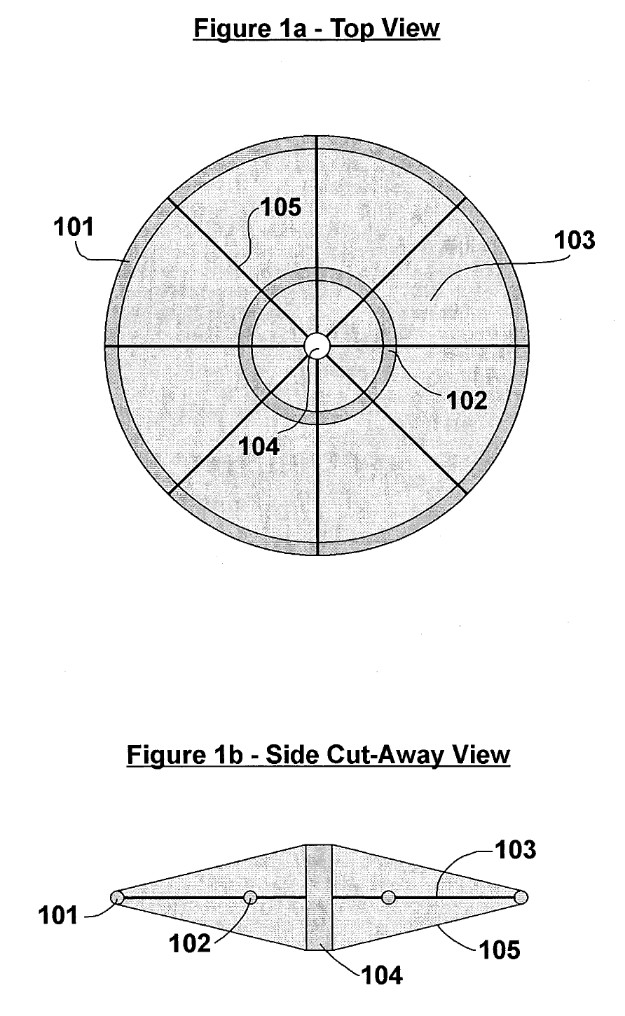

Referring to Figures 1a and 1b, illustrated therein is the top schematic diagram and cut-away side view schematic diagram of the first structural embodiment of part of the subject invention, namely the rigid coil assembly with a single axis receiver. The rigidly joined concentric coaxial bucking coil and receiving coil, shown generally as FIG. 1a (top view) and FIG. 1b (side cut-away view) comprises of bucking coil 101 and receiving coil 102 and a base plane 103 and a central brace 104 and radiating structural members 105. All of the construction material, excluding the wires in the bucking coil and receiver coil, is non-metallic and preferably of fiber and resin material.

The bucking and receiving coils are wound and may be imbedded in epoxy. The embedding of the coil windings in epoxy result in a rigid pair of coils that will not flex nor will the wires inside the coils move relative to each other. The bucking and receiving coils are epoxied together with the base plane. The central brace is epoxied in the exact center of the base plane and the radiating structural members are then epoxied to the base plane and central brace. The result of this construction is an assembly that is inflexible with coaxial bucking and receiving coils.

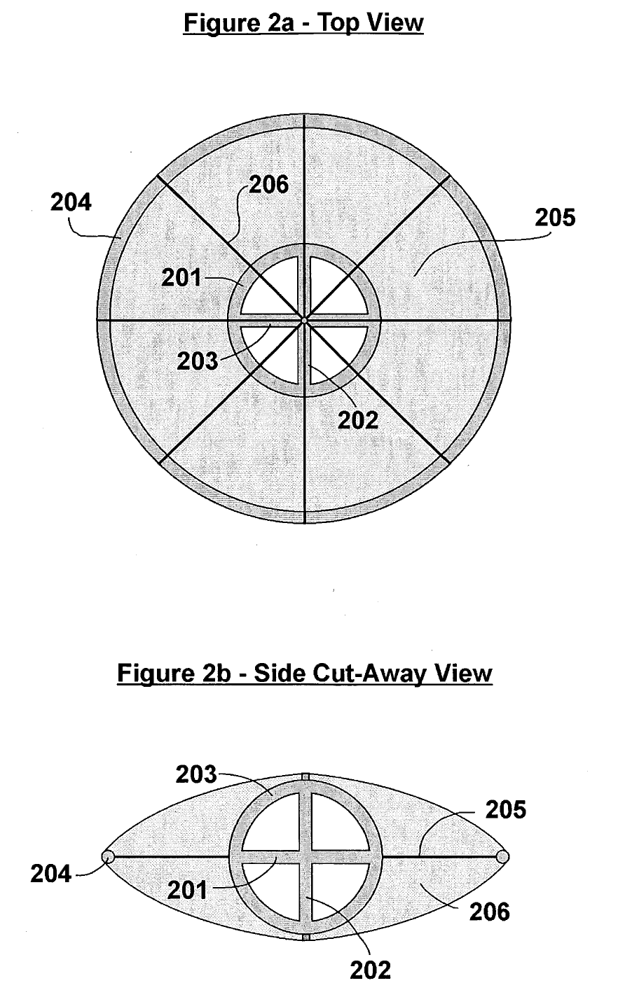

Referring to FIGS. 2a and 2b, illustrated therein is a top view schematic diagram and cut-away side view schematic diagram of the second structural embodiment of part of the subject invention, namely the rigid coil assembly with a 3-axis receiver. This embodiment substitutes a 3-axis receiver assembly for the single axis receiver coil shown in FIG. 1a and 1b. The rigidly joined bucking coil with one coil of the receiver coil assembly in a concentric coaxial relationship to the bucking coil, shown generally as FIG. 2a (top view) and FIG. 2b (side cut-away view) comprises of a receiver coil assembly with two or three coils, one has an axis in the Z (vertical) direction 201 that is coaxial with the bucking coil, one has an axis in the X (horizontal) direction 202, one has an axis in the Y (horizontal) direction 203 and a bucking coil 204 and a base plane 205 and radiating structural members 206. All of the construction material, excluding the wires in the bucking coil and receiver coil, is non-metallic and preferably of fiber and resin material.

The bucking and receiving coils are wound and may be imbedded in epoxy. The embedding of the coil windings in epoxy result in rigid coils that will not flex nor will the wires inside the coils move relative to each other. The bucking and receiving coils are epoxied together with the base plane. The radiating structural members are then epoxied to the base plane and the 3-axis receiver coil. The result of this construction is an assembly that is inflexible with concentric coaxial bucking and one axis of the receiving coils.

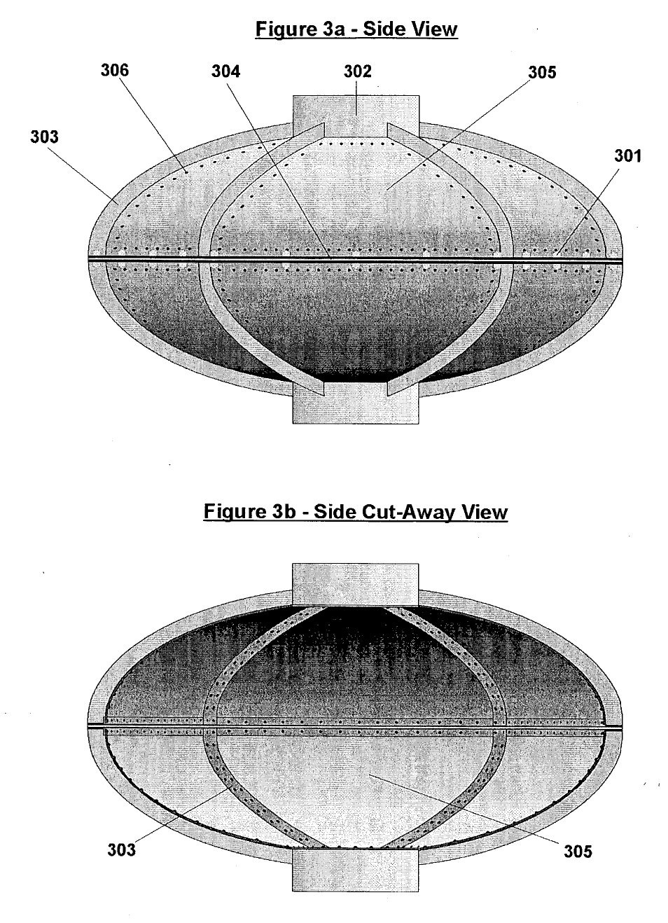

Referring to FIGS. 3a and 3b, illustrated therein are two schematic diagrams of the third structural embodiment of part of the subject invention, namely the container in both closed (FIG. 3a) and open cut-away side views (FIG. 3b) that houses either of the suspended rigid coil assemblies namely the assembly with the single axis receiver or the assembly with the multiple-axis receiver. The embodiment has two identical halves that are bolted together with non-metallic fasteners 301. Describing the top half of the container, there is a tubular central top 302 and structural ribs 303 that radiate from the central top to the base plate 304. Each section of the housing between the base plate at the bottom and the central top and successive pairs of structural ribs contains an area that is covered by a skin 305 that is bolted to the structural ribs and base plate with non-metallic fasteners 306. The inside of the container is shown in FIG. 3b. All of the construction material is non-metallic and preferably of fiber and resin material.

The structural design of the housing in the subject electromagnetometer system is based on the design of a bicycle wheel that has a central axle, spokes and a tire rim. The spokes of a bicycle wheel at their axle end are positioned at either end of the axle and they are attached to the tire rim along the same line. Adjusting the tension of each spoke to a uniform tension results in a rigid wheel. In the case of the subject housing, the vertical axis of the housing is designed to withstand compression forces caused by tension by the use of the solidly joined together structural ribs and the central top and the base plate. The skin that is bolted to the structural members is made of a non-metallic material such as fiberglass and it has sufficient strength to retain its shape while subjected to wind forces caused by the device being towed through the air.

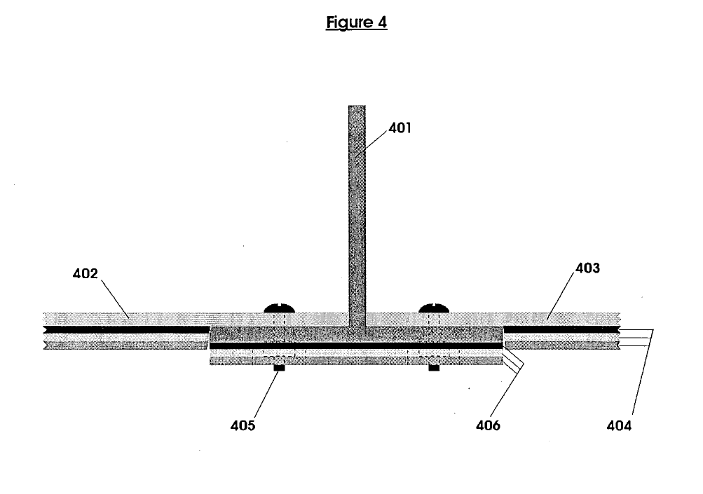

Referring to FIG. 4, illustrated therein is a schematic diagram of the cross sectional view of one of the structural ribs 401 in assembly with two container skins 402 and 403 that are bolted to the structural rib using a fastening device 405 and one or more layers of acoustic dampening material affixed to the interior of the skin 404 and structural member 406. The illustration is cut along both the left and right edges to allow a larger view of the area under discussion in diagram 400.

The structural ribs radiate from the tubular center top section to the base plate. They are made in the form of an inverted “T” out of strong and non-metallic material such as fiberglass and resin or Kevlar and resin. The ribs are part of the structural components of the housing and must be made strong enough to withstand the compression pressures exerted on them.

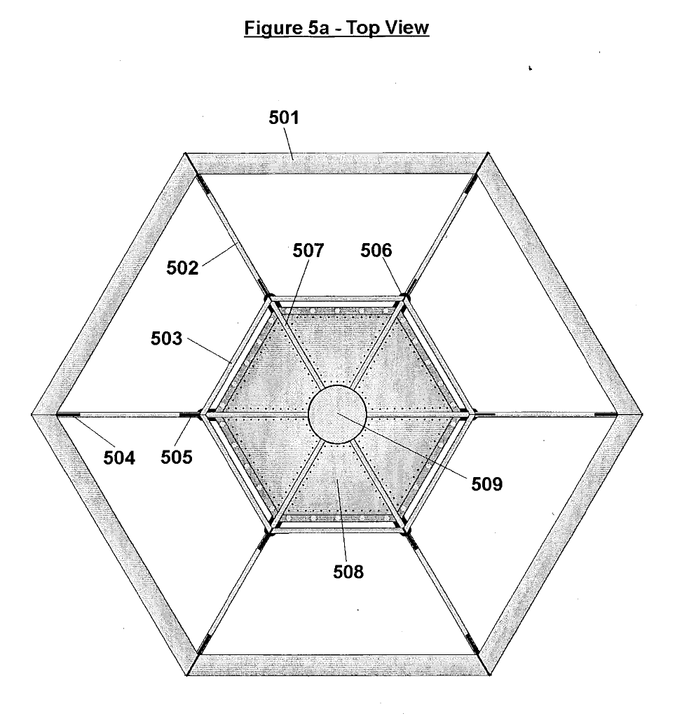

Referring to FIGS. 5a, 5b, and 5c illustrated therein is a schematic diagram of the top view of the subject electromagnetometer system (FIG. 5a) and schematic diagrams of the side view (FIG. 5b) and side cut-away view (FIG. 5c) of the subject electromagnetometer system. The views show the outer transmitter coil in six identical sections 501 and twelve identical structural members 502 radiating from the central part of the electromagnetometer, the structural members are attached by braces 504 at the transmitter and 505 at the central part of the electromagnetometer. The transmitter coil sections and structural members disassemble for shipping. The central part of the electromagnetometer is an embodiment of the subject invention consisting of a central part 509 with multiple identical structural members radiating from the central part 507 that are connected together with multiple structural members 503. These components are rigidly assembled together. The housing 508 is attached to the central part of the electromagnetometer by way of braces 506. All of the construction material is non-metallic and preferably of fiber and resin material.

The top view of the subject electromagnetometer system shows the housing contained within the central part of the system that is a rigid member assembly from which structural members radiate out to the transmitter coil. Tension adjustments on the radiating structural members will cause the transmitter coil to be rigidly positioned relative to the housing contained within the central part.

Referring to FIGS. 5b and 5c, illustrated therein are two schematic diagrams showing part of the embodiment of the subject electromagnetometer system; FIG. 5b is a side view of the subject electromagnetometer system and FIG. 5c is a side cut-away view of the subject electromagnetometer system with no bucking and receiving assembly installed in the housing. The view shows the outer transmitter coil in six identical sections 501 and twelve identical structural members 502 radiating from the central part of the electromagnetometer, the structural members are attached by braces 504 at the transmitter and 505 at the central part of the electromagnetometer. The transmitter coil sections and structural members disassemble for shipping. The central part of the electromagnetometer is an embodiment of the subject invention consisting of two identical halves each with a central core 509 and the structural members shown in the side view 503 with six vertical structural tension tubes 510. The individual central core halves are rigidly assembled together. The housing 508 shown in FIGS. 3a and 3b is attached to the central part of the electromagnetometer by way of braces. FIG. 5c shows the empty interior of the housing. All of the construction material is non-metallic and preferably of fiber and resin material.

The side view of the subject electromagnetometer system shows the housing contained within the central part of the system that is a rigid member assembly from which structural members radiate out to the transmitter coil. Tension adjustments on the radiating structural members will cause the transmitter coil to be rigidly positioned relative to the housing contained within the central part.

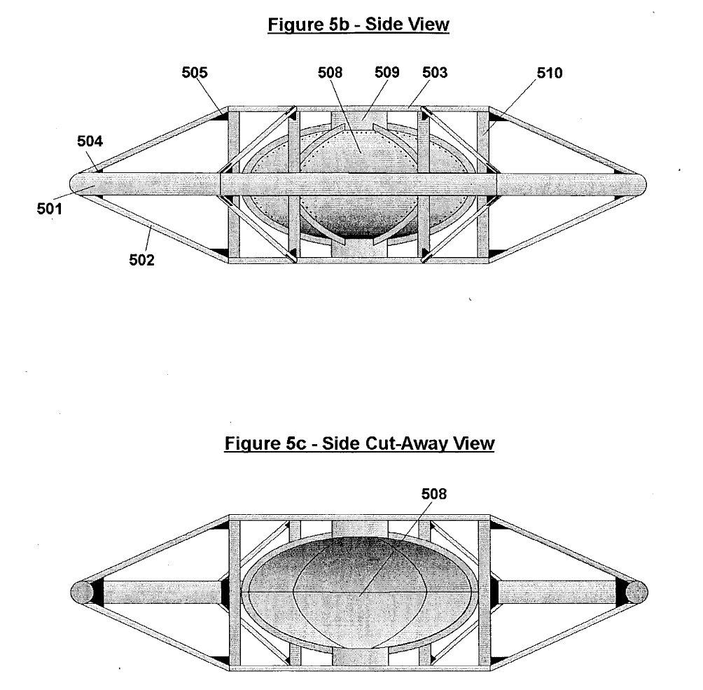

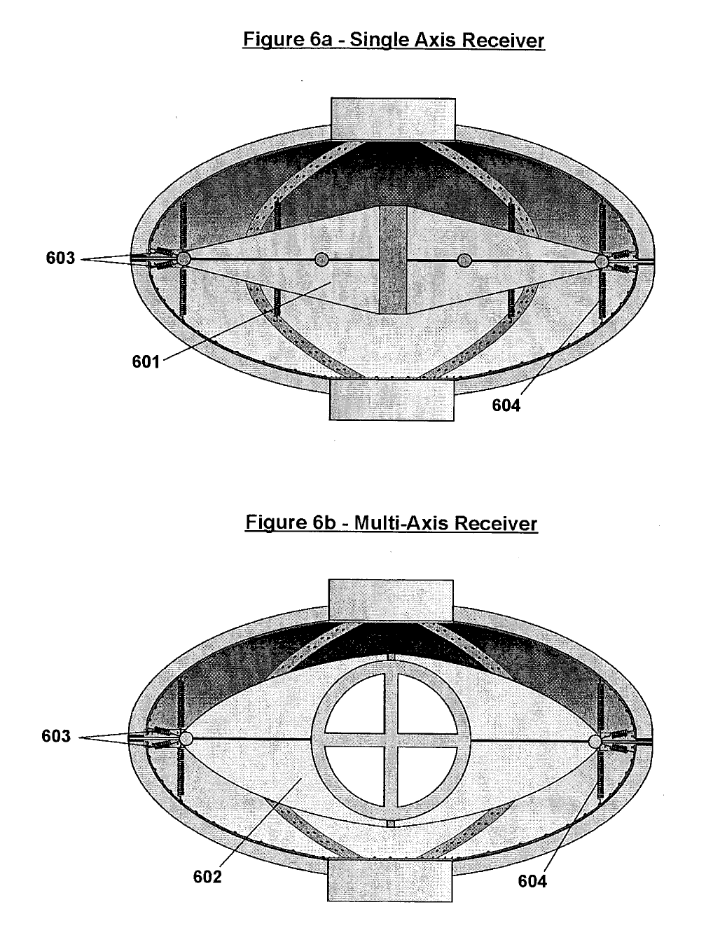

Referring to FIGS. 6a and 6b, illustrated therein are schematic diagrams, FIG. 6a showing the first structural embodiment of part of the subject invention, namely the rigid coil assembly with a single axis receiver 601 and FIG. 6b showing the second structural embodiment of part of the subject invention, namely the rigid coil assembly with a multiple-axis receiver 602. Either assembly is suspended by bungee cords or other vibration dampening material 603 and 604. The schematics in FIGS. 6a and 6b show springs in the locations where the bungee cords or other vibration dampening devices may be positioned. All of the construction material is non-metallic and preferably of fiber and resin material.

The housing in the center of the subject electromagnetometer system is rigidly attached to the central part of the system. The transmitter coil sections are connected to structural members radiating out from the central part. The assembly becomes rigid when proper tension is applied to the radiating structural members. The interior of the housing is open and unobstructed and it may be lined with acoustic or other vibration dampening material. The bucking and receiver coil assembly, either embodiment one with a single axis receiver coil or embodiment two with a 3-axis receiver coil is positioned inside the housing. The bucking and receiving coil assembly is suspended within the housing positioned correctly in the concentric coaxial location relative to the transmitter coil and attached to the housing structural members with bungee cords or other vibration dampening material in a manner that minimizes the bucking and receiving coil angular movement in respect to the transmitter coil but does allow the assembly to move up and down, forward and backward or left and right or any combination of these movements on order to dampen induced movement caused by vibrations or bird flexing.

Thus, while what is shown and described herein constitute preferred embodiments of the subject invention, it should be understood that various changes can be made without departing from the subject invention, the scope of which is defined in the appended claims.

1. A mechanical device which is part of an electromagnetometer design comprising:
a) a rigidly joined bucking and receiving coil assembly;
b) a suspension system suspending the bucking and receiving coil assembly; and
c) an isolation housing in which the suspension system and bucking and receiving coil assembly are enclosed.

2. The mechanical device as claimed in claim 1, wherein the device is used in helicopter towed electromagnetometer systems that have concentric coaxial transmitter, bucking and receiving coils or sets of concentric coaxial transmitter, bucking and receiving coils in various orientations.

3. The mechanical device as claimed in claim 1, wherein the device is used in helicopter towed electromagnetometer systems that have concentric coaxial transmitter, bucking and receiving coils or sets of concentric coaxial transmitter, bucking and receiving coils in various orientations and has an active or passive bucking coil arrangement or arrangements.

4. The mechanical device as claimed in claim 1, wherein the housing is manufactured of strong non-metallic material.

5. The mechanical device as claimed in claim 1, wherein the housing is constructed in two identical halves that are bolted together.

6. The mechanical device as claimed in claim 1, wherein the housing is rigidly assembled with structural members in a manner that does not allow any part of the housing to flex in respect to other parts of the housing.

7. The mechanical device as claimed in claim 1, wherein the housing, when the two halves are joined together with the panels installed, constitutes a housing with a cavity in the interior that is isolated from the outside of the housing.

8. The mechanical device as claimed in claim 1, wherein the cavity within the housing, when the two halves are joined together, is large enough to install the bucking and receiving coil assembly with room to spare for installing the vibration dampening suspension devices.

9. The mechanical device as claimed in claim 1, wherein the housing is lined with vibration dampening material that will minimize external acoustic and other vibrations from entering the chamber within the housing.

10. The mechanical device as claimed in claim 1, wherein the housing has attachment points in its interior to which suspension devices such as bungee cords or other vibration dampening devices are attached.

11. The mechanical device as claimed in claim 1, wherein the joined bucking and receiving coil assembly may consist of a bucking coil and a single receiver coil that are aligned coaxially.

12. The mechanical device as claimed in claim 1, wherein the rigidly joined bucking and receiving coil assembly may consist of a bucking coil and a multiple axis receiver coil with the bucking coil and one axis of the receiver coil aligned coaxially.

13. The mechanical devices as claimed in claims 11 and 12, wherein the joined bucking and receiving coil assembly is manufactured from strong non-metallic materials.

14. The mechanical devices as claimed in claims 11 and 12, wherein the joined bucking and receiving coil assembly is joined rigidly allowing no flexing in any direction.

15. The mechanical devices as claimed in claims 11 and 12, wherein the rigidly joined bucking and receiving coil assembly has dimensions that allow the assembly to fit within the housing with room to spare for installing the vibration dampening suspension devices.

16. The mechanical device as claimed in claim 1, wherein the joined bucking and receiving coil suspension system is attached to the housing and attached to the rigidly joined bucking and receiving coil assembly.

17. The mechanical device as claimed in claim 1, wherein the suspension devices may include various devices or combinations of devices using various materials.

18. The mechanical device as claimed in claim 1, wherein the suspension devices provide a vibration dampening function to the suspended rigidly joined bucking and receiving coil assembly.

19. The mechanical device as claimed in claim 1, wherein the suspension devices are attached to the housing and attached to the rigidly joined bucking and receiving coil assembly in a manner that suppresses angular movements of the coils in the assembly in relationship to the axis transmitter coil.

20. The mechanical device as claimed in claim 1, wherein the suspension devices are attached to the housing and attached to the rigidly joined bucking and receiving coil assembly in a manner that allows minor movement in the forward-back, left-right and up-down directions or combinations of these directions in reference to the coaxial center of the transmitter coil

21. The mechanical device as claimed in claim 1 will be isolated from micro phonic noise vibration generated by exterior structural items vibrating in the wind as the electromagnetometer is flown through the air.

22. The mechanical device as claimed in claim 1, due to accelerations, may be affected by minor movements in the forward-back, left-right and up-down directions or combinations of these directions within the transmitters primary field with little or no harmful affects to the received signals.
